(19) United States
(12) Patent Application Publication
(10) Pub. No.: US 2026/0197474 A1
(43) Pub. Date: Jul. 9, 2026

(54) VIDEO TRANSCODING METHOD AND APPARATUS, ELECTRONIC DEVICE, COMPUTER READABLE STORAGE MEDIUM, AND COMPUTER PROGRAM PRODUCT

(71) Applicant: MOORE THREADS TECHNOLOGY CO., LTD., Beijing (CN)

(72) Inventors: Ziwei LU, Beijing (CN); Ruibo ZHU, Beijing (CN); Liang SHAO, Beijing (CN); Xu HUANG, Beijing (CN); Fengxiang MA, Beijing (CN); Yubo ZHANG, Beijing (CN)

(73) Assignee: MOORE THREADS TECHNOLOGY CO., LTD., Beijing (CN)

(21) Appl. No.: 19/133,754

(22) PCT Filed: Nov. 22, 2023
(86) PCT No.: PCT/CN2023/133401

§ 371 Date: May 29, 2025

(30) Foreign Application Priority Data
Nov. 30, 2022 (CN) 202211513075.0

(51) Int. Cl. H04N 19/40; H04N 19/30

(52) U.S. Cl. CPC H04N 19/40; H04N 19/30

(57) ABSTRACT

Embodiments of the present invention provide a method for video transcoding, an apparatus, an electronic device, a computer readable storage medium, and a computer program product. The method includes: scaling an original video bitstream based on N first preset scaling parameters to obtain N primary scaled video bitstreams with different resolutions, wherein N is a positive integer greater than or equal to 2; scaling a reference primary scaled video bitstream to obtain N-1 secondary scaled video bitstreams corresponding to resolutions of N-1 non-reference primary scaled video bitstreams other than the reference primary scaled video bitstream, wherein the reference primary scaled video bitstream is one of the N primary scaled video bitstreams; determining N-1 residual video bitstreams based on the N-1 non-reference primary scaled video bitstreams and the N-1 secondary scaled video bitstreams; and compressing the reference primary scaled video bitstream and the N-1 residual video bitstreams to obtain video compression data.

### CROSS-REFERENCE TO RELATED APPLICATION

Embodiments of the disclosure are based on and claims priority to Chinese Patent Application No. 202211513075.0 filed on Nov. 30, 2022, the disclosure of which is hereby incorporated by reference in its entirety.

### TECHNICAL FIELD

The disclosure relates to, but is not limited to, the field of computer technology, and in particular to a video transcoding method and apparatus, an electronic device, a computer readable storage medium, and a computer program product.

### BACKGROUND

With the explosive growth of video traffic in the cloud, video coding and decoding computability of a single chip is increasingly unable to meet requirements of video transcoding in various scenarios. In a complex video transcoding scenario, there is an increasing demand to convert one or more original video bitstreams into multiple encoded video bitstreams with different resolutions, different video formats and different image quality characteristics for transmission and storage.

### SUMMARY

Embodiments of the disclosure provide a method for video transcoding, an apparatus, an electronic device, a storage medium, and a computer program product.

An embodiment of the disclosure provides a method for video transcoding, which includes the following operations. Scaling is performed on an original video bitstream based on N first preset scaling parameters to obtain N primary scaled video bitstreams with different resolutions. N is a positive integer greater than or equal to 2. The scaling is performed on a reference primary scaled video bitstream to obtain N-1 secondary scaled video bitstreams corresponding to resolutions of N-1 non-reference primary scaled video bitstreams other than the reference primary scaled video bitstream. The reference primary scaled video bitstream is one of the N primary scaled video bitstreams. N-1 residual video bitstreams are determined based on the N-1 non-reference primary scaled video bitstreams and the N-1 secondary scaled video bitstreams. Compression is performed on the reference primary scaled video bitstream and the N-1 residual video bitstreams to obtain video compression data.

An embodiment of the disclosure provides a method for video transcoding, which includes the following operations. Video compression data is read from a Double Data Rate (DDR) memory. The video compression data is obtained according to the above method. Decompression is performed on the video compression data to obtain a reference primary scaled video bitstream and N-1 residual video bitstreams. N is a positive integer greater than or equal to 2. N primary scaled video bitstreams are recovered based on the reference primary scaled video bitstream and the N-1 residual video bitstreams. Encoding is performed on each of the recovered N primary scaled video bitstreams to obtain N encoded video bitstreams.

An embodiment of the disclosure provides an apparatus for video transcoding, which includes a first scaling processing component, a second scaling processing component, a determination component and a compression processing component. The first scaling processing component is configured to scale an original video bitstream based on N first preset scaling parameters to obtain N primary scaled video bitstreams with different resolutions. N is a positive integer greater than or equal to 2. The second scaling processing component is configured to scale a reference primary scaled video bitstream to obtain N-1 secondary scaled video bitstreams corresponding to resolutions of N-1 non-reference primary scaled video bitstreams other than the reference primary scaled video bitstream. The reference primary scaled video bitstream is one of the N primary scaled video bitstreams. The determination component is configured to determine N-1 residual video bitstreams based on the N-1 non-reference primary scaled video bitstreams and the N-1 secondary scaled video bitstreams. The compression processing component is configured to compress the reference primary scaled video bitstream and the N-1 residual video bitstreams to obtain video compression data.

An embodiment of the disclosure provides an apparatus for video transcoding, which includes a reading component, a decompression processing component, a recovery component and an encoding component. The reading component is configured to read video compression data from a DDR memory. The video compression data is obtained according to the above method. The decompression processing component is configured to decompress the video compression data to obtain a reference primary scaled video bitstream and N-1 residual video bitstreams. N is a positive integer greater than or equal to 2. The recovery component is configured to recover N primary scaled video bitstreams based on the reference primary scaled video bitstream and the N-1 residual video bitstreams. The encoding component is configured to encode each of the recovered N primary scaled video bitstreams to obtain N encoded video bitstreams.

An embodiment of the disclosure provides an electronic device, which includes a processor and a memory for storing instructions executable by the processor. The processor is configured to call the instructions stored in the memory to perform the above method.

An embodiment of the disclosure provides a computer-readable storage medium having stored thereon computer program instructions that, when executed by a processor, implement the above method.

An embodiment of the disclosure provides a computer program product including a computer program or instructions that, when run on an electronic device, enable the electronic device to perform any one of the above methods.

In the embodiments of the disclosure, scaling is performed on an original video bitstream based on N first preset scaling parameters to obtain N primary scaled video bitstreams with different resolutions. N is a positive integer greater than or equal to 2. The scaling is performed on a reference primary scaled video bitstream to obtain N-1 secondary scaled video bitstreams corresponding to resolutions of N-1 non-reference primary scaled video bitstreams other than the reference primary scaled video bitstream. The reference primary scaled video bitstream is one of the N primary scaled video bitstreams. N-1 residual video bitstreams are determined based on the N-1 non-reference primary scaled video bitstreams and the N-1 secondary scaled video bitstreams. Compression is performed on the reference primary scaled video bitstream and the N-1 residual video bitstreams to obtain video compression data. In a complex video transcoding scenario, the residual video bitstream is determined through two scaling operations, which may effectively reduce the amount of data that needs to be transmitted and stored during the video transcoding process, and then effectively reduce the occupancy rate of the DDR memory and bandwidth during the video transcoding process, thereby improving the video transcoding efficiency.

It is to be understood that the above general description and the detailed description below are only exemplary and explanatory, instead of limiting the disclosure.

### BRIEF DESCRIPTION OF THE DRAWINGS

In order to illustrate the technical solution of the embodiments of the disclosure more clearly, drawings to be used in the embodiments of the disclosure are illustrated in the following.

The drawings here are incorporated into and form a part of the specification, which illustrate embodiments conforming to the disclosure and are used in combination with the specification to illustrate the technical solution of the disclosure.

FIG. 1 is a schematic flowchart of a method for video transcoding provided by an embodiment of the disclosure.

FIG. 2 is a structural diagram of a system for video transcoding provided by an embodiment of the disclosure.

FIG. 3 is a schematic flowchart of a method for video transcoding provided by an embodiment of the disclosure.

FIG. 4 is a structural diagram of respectively encoding 4 transcoding tasks provided by an embodiment of the disclosure.

FIG. 5 is a structural diagram of a system for video transcoding provided by an embodiment of the disclosure.

FIG. 6 is a structural diagram of a system for video transcoding provided by an embodiment of the disclosure.

FIG. 7 is a block diagram of an apparatus for video transcoding provided by an embodiment of the disclosure.

FIG. 8 is a block diagram of an apparatus for video transcoding provided by an embodiment of the disclosure.

FIG. 9 is a block diagram of an electronic device provided by an embodiment of the disclosure.

FIG. 10 is a block diagram of an electronic device provided by an embodiment of the disclosure.

### DETAILED DESCRIPTION

In order to enable those skilled in the art to better understand the technical solution of the disclosure, the technical solution in the embodiments of the disclosure will be described clearly and completely below in combination with the drawings in the embodiments of the disclosure. It is apparent that the described embodiments are a part of the embodiments of the disclosure, rather than all of the embodiments. Based on the embodiments in the disclosure, all other embodiments obtained by those of ordinary skill in the art without creative labor fall within the scope of protection of the disclosure.

Terms “first”, “second”, or the like, in the description, the claims, and the above [0027] drawings of the disclosure are used to distinguish different objects, rather than to describe a specific order. In addition, terms “include” and “have”, as well as any variation thereof, are intended to cover non-exclusive inclusion. For example, a process, a method, a system, a product, or a device that includes a series of operations or units is not limited to the listed operations or units, but may further optionally include other operations or units that are not listed, or may further optionally include other operations or units inherent to these processes, methods, products, or devices.

It is to be understood that in the disclosure, “at least one” refers to one or more, “multiple” refers to two or more, and “at least two” refers to two, or three or more than three. “And/or” is used to describe an association relationship between associated objects, which may represent that there may be three kinds of relationships. For example, “A and/or B” may represent three cases, i.e., independent existence of A, independent existence of B, and existence of both A and B. Here, A and B may be singular or plural. The character “/” may represent that the previous and next associated objects are in an “or” relationship, which refers to any combination of these items, including any combination of a single item or multiple items. For example, “at least one of a, b or c” may represent: “a”, “b”, “c”, “a and b”, “a and c”, “b and c”, or “a, b and c”. Here, a, b, and c may be single or multiple. The character “/” may also represent a division sign in a mathematical operation, for example, a/b=a divided by b; and 6/3=2. “At least one of the following” or similar expressions.

With the explosive growth of video traffic in the cloud, video coding and decoding computability of a single chip is increasingly unable to meet requirements of video transcoding in various scenarios. In a complex video transcoding scenario, there is an increasing demand to convert one or more original video bitstreams into multiple encoded video bitstreams with different resolutions, different video formats and different image quality characteristics for transmission and storage.

In the related art, scaling is performed on an original video bitstream output by a decoder according to a fixed ratio (e.g., one-fourth, one-half, one-eighth, or the like) down-sampling method, and the scaled video data is then directly stored in the DDR memory. Due to factors such as different rate matching conditions of the encoder and the decoder, in order to enable the end user to obtain the required encoded video data, it is necessary to select different encoders to perform encoding processing according to different scenario requirements, resolutions, video formats and devices. Therefore, it is often necessary to cache multiple streams of video data with different resolutions in the DDR memory.

Therefore, the above method for video transcoding may achieve parallel transcoding in a complex video transcoding scenario, but multiple streams of scaled video data streams with different resolutions are stored in the DDR memory, which will significantly occupy the DDR memory and bandwidth, thereby affecting data transmission and encoding efficiency of the entire system for video transcoding.

In the related art, the original video bitstream output by the decoder may also be directly stored in the DDR memory without scaling. Only one stream of original video bitstream is stored in the DDR memory, which reduces occupancy of the DDR memory. However, due to factors such as different rate matching conditions of the encoder and the decoder, when different video resolutions and video formats are required in different scenarios and on different devices, a large amount of memories and a complex management mechanism are needed to complete different scaling operations on the original video bitstream. This leads to the fact that in a complex video transcoding scenario, the designed power consumption and area of the chip for running the system for video transcoding are very large.

In addition, in the related art, the original video bitstream may only be scaled based on a fixed scaling ratio, which limits the resolution of the output video bitstream, thereby resulting in poor flexibility of video transcoding.

To efficiently achieve the video transcoding in a complex video transcoding scenario, the disclosure provides a method for video transcoding, which may not only effectively reduce the occupancy rate of the DDR memory and bandwidth during the video transcoding process, but also meet the requirements of video transcoding of different resolutions. The method for video transcoding provided by the disclosure is introduced in detail below.

FIG. 1 is a schematic flowchart of a method for video transcoding of an embodiment of the disclosure. The method may be performed by an electronic device such as a terminal device or a server. The terminal device may be a User Equipment (UE), a mobile device, a user terminal, a terminal, a cellular phone, a cordless phone, a Personal Digital Assistant (PDA), a handheld device, a computing device, an onboard device, a wearable device, or the like. The method may be implemented by a processor calling computer-readable instructions stored in a memory. Alternatively, the method may be performed by a server. As shown in FIG. 1, the method includes operations S11 to S14.

In operation S11, scaling is performed on an original video bitstream based on N first preset scaling parameters to obtain N primary scaled video bitstreams with different resolutions. N is a positive integer greater than or equal to 2.

The specific number of the N first preset scaling parameters and the specific value of each first preset scaling parameter are related to encoding requirements during the actual transcoding process, which may be set and adjusted according to the actual situation, and are not specifically limited in the disclosure.

For example, when the encoding requirement is to obtain four encoded video bitstreams with the first resolution, the second resolution, the third resolution, and the fourth resolution, the encoding requirement may be divided into 4 transcoding tasks. In such case, N is 4, i.e., 4 first preset scaling parameters are configured. Based on the 4 first preset scaling parameters, scaling is performed on the original video bitstream to obtain 4 primary scaled video bitstreams, i.e., s_0 that has the first resolution and corresponds to transcoding task 0, s_1 that has the second resolution and corresponds to transcoding task 1, s_2 that has the third resolution and corresponds to transcoding task 2, and s_3 that has the fourth resolution and corresponds to transcoding task 3. Resolutions of the 4 primary scaled video bitstreams are different from each other.

First preset scaling parameters of different numbers and different values are flexibly set according to the encoding requirement, so that requirements in different video transcoding scenarios may be effectively met.

In some implementations, the method further includes the following operations. A video bitstream to be processed is acquired. Decoding is performed on the video bitstream to be processed to obtain the original video bitstream.

The video bitstream to be processed may be an encoded video bitstream received from an external source or stored locally. The system for video transcoding needs to transcode the video bitstream to be processed into encoded video bitstreams with other encoding formats and resolutions. Therefore, the decoding is firstly performed on the video bitstream to be processed to obtain the original video bitstream, i.e., an uncoded video bitstream.

In operation S12, the scaling is performed on a reference primary scaled video bitstream to obtain N-1 secondary scaled video bitstreams corresponding to resolutions of N-1 non-reference primary scaled video bitstreams other than the reference primary scaled video bitstream. The reference primary scaled video bitstream is one of the N primary scaled video bitstreams.

In order to avoid excessive occupancy of the DDR memory and bandwidth caused by directly storing the N primary scaled video bitstreams, any one or a preset one of the N primary scaled video bitstreams is selected as the reference primary scaled video bitstream. Secondary scaling is then performed on the reference primary scaled video bitstream to obtain the N-1 secondary scaled video bitstreams corresponding to the resolutions of the N-1 non-reference primary scaled video bitstreams other than the reference primary scaled video bitstream, so as to prepare for the subsequent reduction of video data volume.

In some implementations, the reference primary scaled video bitstream is a primary scaled video bitstream with the lowest resolution among the N primary scaled video bitstreams.

To reduce the occupancy of the DDR memory and bandwidth as far as possible, the primary scaled video bitstream with the lowest resolution among the N primary scaled video bitstreams may be determined as the reference primary scaled video bitstream.

The primary scaled video bitstreams s_0, s_1, s_2 and s_3 corresponding to the above 4 transcoding tasks are taken as an example. When the first resolution is lower than the second to fourth resolutions, the primary scaled video bitstream s_0 that has the first resolution and corresponds to the transcoding task 0 may be selected as the reference primary scaled video bitstream.

In addition to selecting the primary scaled video bitstream with the lowest resolution among the N primary scaled video bitstreams as the reference primary scaled video bitstream, a primary scaled video bitstream with any resolution may also be selected according to the actual situation, which is not specifically limited by the disclosure. In the following, the method for video transcoding of the embodiments of the disclosure is described taking the primary scaled video bitstream with the lowest resolution as the reference primary scaled video bitstream, which, however, does not constitute any limitation on the embodiments of the disclosure.

In some implementations, the method further includes the following operation. Image enhancement is performed on each of the N primary scaled video bitstreams before the scaling is performed on the reference primary scaled video bitstream.

The N primary scaled video bitstreams obtained by the primary scaling may have loss in effective image information. Therefore, the image enhancement may be performed on each of the N primary scaled video bitstreams before the secondary scaling is performed, thereby effectively reducing the loss in the effective image information.

The primary scaled video bitstreams s_0, s_1, s_2 and s_3 corresponding to the above 4 transcoding tasks are taken as an example. The image enhancement is performed on each of the primary scaled video bitstreams s_0, s_1, s_2 and s_3 corresponding to the 4 transcoding tasks to obtain primary scaled video bitstreams s0_e, s1_e, s2_e and s3_e after the image enhancement corresponding to the 4 transcoding tasks. In such case, the primary scaled video bitstream s0_e, which is obtained by the performing the image enhancement on the primary scaled video bitstream s_0 with the lowest resolution and corresponding to the transcoding task 0, may be selected as the reference primary scaled video bitstream.

In some implementations, the image enhancement processing includes at least one of: edge information enhancement processing, blurring processing, or color transformation processing.

The specific processing mode of the image enhancement processing may be determined according to the actual situation. In addition to the above processing, other image enhancement processing modes may also be set for the specific processing mode of the image enhancement, which is not specifically limited by the disclosure.

After the reference primary scaled video bitstream is determined, the scaling is performed on the reference primary scaled video bitstream to obtain the N-1 secondary scaled video bitstreams corresponding to the resolutions of the N-1 non-reference primary scaled video bitstreams.

The primary scaled video bitstreams s0_e, s1_e, s2_e, and s3_e corresponding to the above 4 transcoding tasks, and a case where the primary scaled video bitstream s0_e that has the first resolution and corresponds to the transcoding task 0 is the reference primary scaled video bitstream are taken as an example. The scaling is performed on the reference primary scaled video bitstream s0_e that has the first resolution and corresponds to the transcoding task 0, so as to obtain: a secondary scaled video bitstream s0_1 with the second resolution (which has the same resolution as the non-reference primary scaled video bitstream s1_e that has the second resolution and corresponds to the transcoding task 1), a secondary scaled video bitstream s0_2 with the third resolution (which has the same resolution as the non-reference primary scaled video bitstream s2_e that has the third resolution and corresponds to the transcoding task 2), and a secondary scaled video bitstream s0_3 with the fourth resolution (which has the same resolution as the non-reference primary scaled video bitstream s3_e that has the fourth resolution and corresponds to the transcoding task 3).

In operation S13, N-1 residual video bitstreams are determined based on the N-1 non-reference primary scaled video bitstreams and the N-1 secondary scaled video bitstreams.

For the N-1 non-reference primary scaled video bitstreams and the N-1 secondary scaled video bitstreams with corresponding resolutions, pixel differences between corresponding video frames are determined to obtain the N-1 residual video bitstreams.

The above 3 non-reference primary scaled video bitstreams s1_e, s2_e and s3_e, and the 3 secondary scaled video bitstreams s0_1, s0_2 and s0_3 with corresponding resolutions are taken as an example. A pixel difference between corresponding video frames of the non-reference primary scaled video bitstream s1_e and the secondary scaled video bitstream s0_1, which have the second resolution, is determined to obtain a residual video bitstream s1_res=s1_e−s0_1 that has the second resolution and corresponds to the transcoding task 1. A pixel difference between corresponding video frames of the non-reference primary scaled video bitstream s2_e and the secondary scaled video bitstream s0_2, which have the third resolution, is determined to obtain a residual video bitstream s2_res=s2_e−s0_2 that has the third resolution and corresponds to the transcoding task 2. A pixel difference between corresponding video frames of the non-reference primary scaled video bitstream s3_e and the secondary scaled video bitstream s0_3, which have the fourth resolution, is determined to obtain a residual video bitstream s3_res=s3_e−s0_3 that has the fourth resolution and corresponds to the transcoding task 3.

In operation S14, compression is performed on the reference primary scaled video bitstream and the N-1 residual video bitstreams to obtain video compression data.

Since the residual video bitstreams record the pixel differences close to or equal to 0, after the compression is performed on the residual video bitstreams, the video data volume may be greatly reduced. In addition, according to the reference primary scaled video bitstream and the N-1 residual video bitstreams, the primary scaled video bitstreams corresponding to the N transcoding tasks may be recovered subsequently. Therefore, by compressing the reference primary scaled video bitstream and the N-1 residual video bitstreams, not only the video compression data can be obtained, but also the amount of data that needs to be transmitted and stored during the video transcoding process may be reduced, thereby effectively reducing the occupancy rate of the DDR memory and bandwidth during the video transcoding process and improving the video transcoding efficiency.

In the embodiments of the disclosure, in a complex video transcoding scenario, the residual video bitstream is determined through two scaling operations, which may effectively reduce the amount of data that needs to be transmitted and stored during the video transcoding process, thereby effectively reducing the occupancy rate of the DDR memory and bandwidth during the video transcoding process and improving the video transcoding efficiency.

In some implementations, the video compression data may include first video compression data. The operation that the compression is performed on the reference primary scaled video bitstream to obtain the video compression data in the operation S14 includes the following operation. The compression is performed on the reference primary scaled video bitstream based on an intra lossless compression mode to obtain the first video compression data.

Since the reference primary scaled video bitstream is the basis for subsequently recovering the N-1 primary scaled video bitstreams, the compression is performed on the reference primary scaled video bitstream through the intra lossless compression mode to obtain the first video compression data. In addition to the intra lossless compression mode, other general video compression modes may also be adopted, which is not specifically limited by the disclosure.

In some implementations, the video compression data may include second video compression data. The operation that the compression is performed on the N-1 residual video bitstreams to obtain the video compression data in the operation S14 includes the following operation. The compression is performed on the N-1 residual video bitstreams based on a time-domain to frequency-domain compression mode to obtain the second video compression data.

Since the residual video bitstreams record pixel differences close to or equal to 0 and have a large amount of redundancy in space, the compression is performed on the N-1 residual video bitstreams through the time-domain to frequency-domain compression mode to obtain the second video compression data, which may further increase the compression ratio of video image frames on a small number of low-frequency coefficients, effectively remove spatial redundancy, and greatly reduce data volume.

In some implementations, the method further includes the following operation. The video compression data is stored in the DDR memory.

The video compression data obtained by compressing the reference primary scaled video bitstream and the N-1 residual video bitstreams is stored in the DDR memory to prepare for subsequent video encoding.

The above reference primary scaled video bitstream s0_e, and the three residual video bitstreams s1_res, s2_res and s3_res are taken as an example. The compression is performed on the reference primary scaled video bitstream s0_e through the intra lossless compression mode to obtain the first video compression data corresponding to the transcoding task 0. The compression is performed on each of the three residual video bitstreams s1_res, s2_res and s3_res through the time-domain to frequency-domain compression mode to obtain the second video compression data corresponding to transcoding the tasks 1 to 3. The first video compression data and the second video compression data are stored in the DDR memory.

The first video compression data and the second video compression data with greatly reduced data volume, which are obtained after the compression is performed on the reference primary scaled video bitstream and the N-1 residual video bitstreams, are stored in the DDR memory, thereby effectively reducing the occupancy rate of the DDR memory and bandwidth during the video transcoding process.

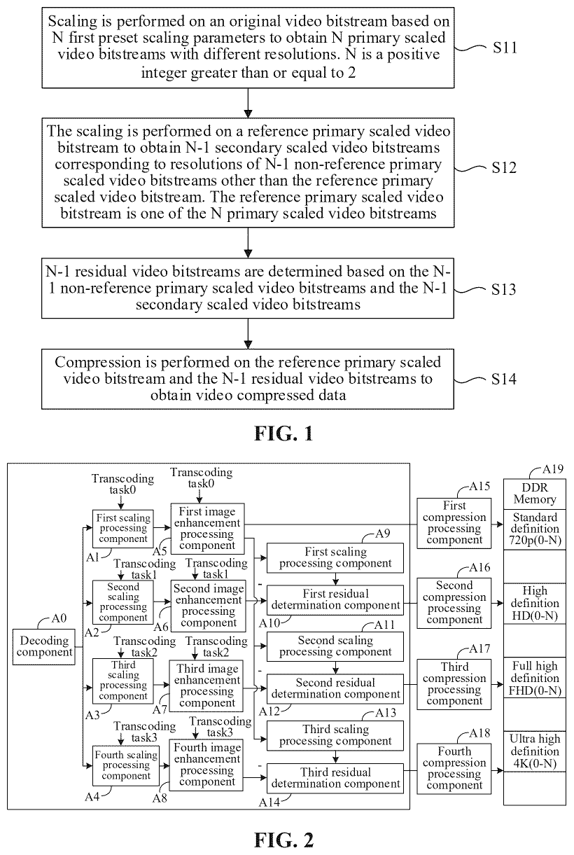

FIG. 2 is a structural diagram of a system for video transcoding provided by an embodiment of the disclosure. As shown in FIG. 2, the system for video transcoding includes a decoding component A0. The decoding component A0 is configured to decode the video bitstream to be processed to obtain the original video bitstream.

The system for video transcoding further includes a first scaling processing component A1, a second scaling processing component A2, a third scaling processing component A3 and a fourth scaling processing component A4, which may be configured with parameters. According to actual requirements, corresponding scaling algorithms and corresponding first preset scaling parameters may be configured for the first scaling processing component A1, the second scaling processing component A2, the third scaling processing component A3 and the fourth scaling processing component A4. Based on the first preset scaling parameters corresponding to the first scaling processing component A1, the second scaling processing component A2, the third scaling processing component A3 and the fourth scaling processing component A4, scaling is performed on the original video bitstream output by the decoding component A0 to obtain primary scaled video bitstreams corresponding to different transcoding tasks.

The system for video transcoding further includes a first image enhancement processing component A5, a second image enhancement processing component A6, a third image enhancement processing component A7 and a fourth image enhancement processing component A8, which may be configured with parameters. According to actual requirements, corresponding image enhancement processing algorithms may be configured for the first image enhancement processing component A5, the second image enhancement processing component A6, the third image enhancement processing component A7 and the fourth image enhancement processing component A8. Based on the first image enhancement processing component A5, the second image enhancement processing component A6, the third image enhancement processing component A7 and the fourth image enhancement processing component A8, image enhancement is performed on each of the primary scaled video bitstreams corresponding to different transcoding tasks, thereby reducing the loss in the effective video information.

The primary scaled video bitstream that corresponds to the transcoding task 0 and is output by the second image enhancement processing component A6 is selected as the reference primary scaled video bitstream. The system for video transcoding further includes a first scaling processing component A9, a second scaling processing component A11 and a third scaling processing component A13. The first scaling processing component A9 scales the reference primary scaled video bitstream that corresponds to the transcoding task 0 and is output by the first image enhancement processing component A5 to obtain secondary scaled video bitstreams with the same resolutions as the non-reference primary scaled video bitstreams that correspond to the transcoding task 1 and are output by the second image enhancement processing component A6. The second scaling processing component A11 scales the reference primary scaled video bitstream that corresponds to the transcoding task 0 and is output by the first image enhancement processing component A5 to obtain secondary scaled video bitstreams with the same resolutions as the non-reference primary scaled video bitstreams that correspond to the transcoding task 2 and are output by the third image enhancement processing component A7. The third scaling processing component A13 scales the reference primary scaled video bitstream that corresponds to the transcoding task 0 and is output by the first image enhancement processing component A5 to obtain secondary scaled video bitstreams with the same resolutions as the non-reference primary scaled video bitstreams that correspond to the transcoding task 3 and are output by the fourth image enhancement processing component A8.

The system for video transcoding further includes a first residual determination component A10, a second residual determination component A12 and a third residual determination component A14. The first residual determination component A10 is configured to calculate the pixel difference between the primary scaled video bitstream that corresponds to the transcoding task 1 and is output by the second image enhancement processing component A6, and the secondary scaled video bitstream that corresponds to the transcoding task 1 and is output by the first scaling processing component A9, so as to determine a residual video bitstream corresponding to the transcoding task 1. The second residual determination component A12 is configured to calculate the pixel difference between the primary scaled video bitstream that corresponds to the transcoding task 2 and is output by the third image enhancement processing component A7, and the secondary scaled video bitstream that corresponds to the transcoding task 2 and is output by the second scaling processing component A11, so as to determine a residual video bitstream corresponding to the transcoding task 2. The third residual determination component A14 is configured to calculate the pixel difference between the primary scaled video bitstream that corresponds to the transcoding task 3 and is output by the fourth image enhancement processing component A8, and the secondary scaled video bitstream that corresponds to the transcoding task 3 and is output by the third scaling processing component A13, so as to determine a residual video bitstream corresponding to the transcoding task 3.

The system for video transcoding further includes a first compression processing component A15. The first compression processing component A15 is configured to compress the reference primary scaled video bitstream that corresponds to the transcoding task 0 and is output by the first image enhancement processing component A5 through a general video compression mode (e.g., the intra lossless compression mode) to obtain first video compression data corresponding to the transcoding task 0 (e.g., 720p (0-N) shown in FIG. 2).

The system for video transcoding further includes a second compression processing component A16, a third compression processing component A17 and a fourth compression processing component A18. Each of the second compression processing component A16, the third compression processing component A17 and the fourth compression processing components A18 is configured to compress a respective one of the residual video bitstreams that correspond to the transcoding tasks 1 to 3 and are output by the first residual determination component A10, the second residual determination component A12 and the third residual determination component A14 through the time-domain to frequency-domain compression mode, so as to obtain second video compression data corresponding to the transcoding tasks 1 to 3.

The system for video transcoding further includes a DDR memory A19. The first video compression data that corresponds to the transcoding task 0 and is output by the first compression processing component A15 (e.g., 720p (0-N) shown in FIG. 2), and the second video compression data that corresponds to the transcoding tasks 1 to 3 and is output by the second compression processing component A16, the third compression processing component A17 and the fourth compression processing component A18 (e.g., High Definition (HD) (0-N), Full High Definition (FHD) (0-N) and Ultra High Definition (4K) (0-N) shown in FIG. 2), are stored in the DDR memory A19.

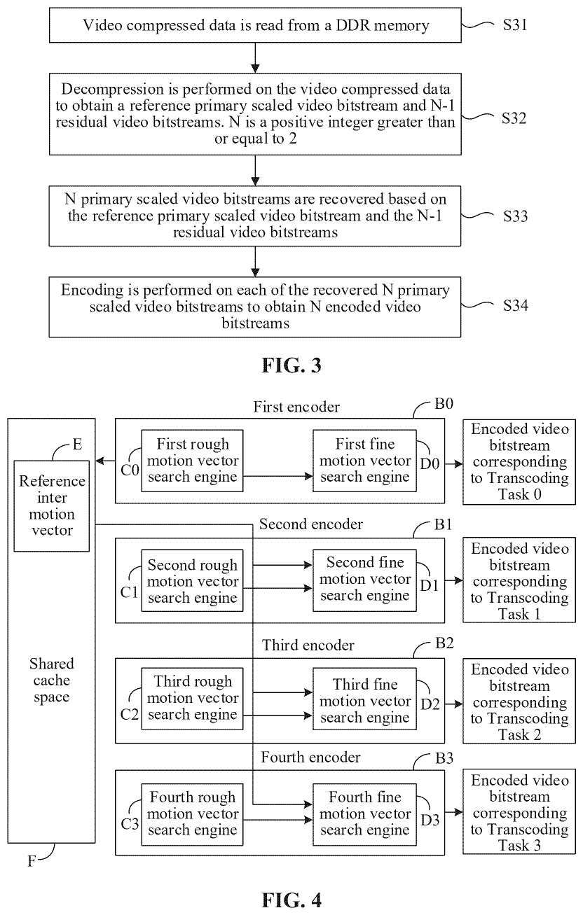

FIG. 3 is a schematic flowchart of a video transcoding method provided by an embodiment of the disclosure. The method may be performed by an electronic device such as a terminal device or a server. The terminal device may be a User Equipment (UE), a mobile device, a user terminal, a terminal, a cellular phone, a cordless phone, a Personal Digital Assistant (PDA), a handheld device, a computing device, an onboard device, a wearable device, or the like. The method may be implemented by a processor calling computer-readable instructions stored in a memory. Alternatively, the method may be performed by a server. As shown in FIG. 3, the method includes operations S31 to S34.

In operation S31, video compression data is read from a DDR memory.

When video encoding is required, corresponding video compression data is read from the DDR memory. The video compression data is obtained based on the above embodiments shown in at least one of FIG. 1 or FIG. 2.

In operation S32, decompression is performed on the video compression data to obtain a reference primary scaled video bitstream and N-1 residual video bitstreams. N is a positive integer greater than or equal to 2.

In operation S33, N primary scaled video bitstreams are recovered based on the reference primary scaled video bitstream and the N-1 residual video bitstreams.

By decompressing the video compression data, the reference primary scaled video bitstream and the N-1 residual video bitstreams may be obtained, and then the N primary scaled video bitstreams required for the video encoding are recovered.

In operation S34, encoding is performed on each of the recovered N primary scaled video bitstreams to obtain N encoded video bitstreams.

The encoding process will be described in detail below in combination with some implementations of the disclosure.

In some implementations, the video compression data includes first video compression data. The operation that the decompression is performed on the video compression data to obtain the reference primary scaled video bitstream in the operation S32 includes the following operation. The decompression is performed on the first video compression data based on an intra lossless decompression mode to obtain the reference primary scaled video bitstream.

For example, the decompression is performed on the first video compression data by the intra lossless decompression mode to obtain a reference primary scaled video bitstream s0_e that has a first resolution and corresponds to the transcoding task 0.

In some implementations, the video compression data includes second video compression data. The operation that the decompression is performed on the video compression data to obtain the N-1 residual video bitstreams in the operation S32 includes the following operation. The decompression is performed on the second video compression data based on a frequency-domain to time-domain decompression mode to obtain the N-1 residual video bitstreams.

For example, the decompression is performed on the second video compression data by the frequency-domain to time-domain decompression mode to obtain a residual video bitstream s1_res that has a second resolution and corresponds to the transcoding task 1, a residual video bitstream s2_res that has a third resolution and corresponds to the transcoding task 2, and a residual video bitstream s3_res that has a fourth resolution and corresponds to the transcoding task 3.

Secondary compression is performed on the reference primary scaled video bitstream s0_e that has a first resolution and corresponds to the transcoding task 0 to respectively obtain a secondary scaled video bitstream s0_1 that has the second resolution and corresponds to the transcoding task 1, a secondary scaled video bitstream s0_2 that has the third resolution and corresponds to the transcoding task 2, and a secondary scaled video bitstream s0_3 that has the fourth resolution and corresponds to the transcoding task 3. Then, a primary scaled video bitstream s1_e=s0_1+s1_res that has the second resolution and corresponds to the transcoding task 1, a primary scaled video bitstream s2_e=s0_2+s2_res that has the third resolution and corresponds to the transcoding task 2, and a primary scaled video bitstream s3_e=s0_3+s3_res that has the fourth resolution and corresponds to the transcoding task 3 are recovered.

The residual video bitstreams are only used as intermediate processing of data transmission and storage, and it is still the N primary scaled video bitstreams that are finally encoded. Therefore, the secondary scaling will not cause the loss in the effective information of the video data, i.e., will not affect the quality of the final encoded video bitstream.

In some implementations, during the encoding, the N primary scaled video bitstreams share a reference inter motion vector corresponding to the reference primary scaled video bitstream.

The N-1 non-reference primary scaled video bitstreams are obtained by scaling the reference primary scaled video bitstream. Therefore, during the encoding process, the N-1 non-reference primary scaled video bitstreams may share the reference inter motion vector corresponding to the reference primary scaled video bitstream, which improves the accuracy of inter prediction, thereby improving the encoding performance.

In some implementations, corresponding encoders may be selected according to encoding requirements to encode primary scaled video bitstreams corresponding to different transcoding tasks.

In some implementations, the operation that the encoding is performed on each of the recovered N primary scaled video bitstreams to obtain the N encoded video bitstreams includes the following operations. Rough motion vector search is performed on the reference primary scaled video bitstream to determine the reference inter motion vector corresponding to the reference primary scaled video bitstream. Fine motion vector search is performed on the reference primary scaled video bitstream based on the reference inter motion vector corresponding to the reference primary scaled video bitstream to determine a target inter motion vector corresponding to the reference primary scaled video bitstream. The encoding is performed on the reference primary scaled video bitstream based on the target inter motion vector corresponding to the reference primary scaled video bitstream to obtain an encoded video bitstream corresponding to the reference primary scaled video bitstream.

Inter prediction of the encoding process includes the rough motion vector search and the fine motion vector search. The rough motion vector search is performed on the reference primary scaled video bitstream to determine the reference inter motion vector corresponding to the reference primary scaled video bitstream. Then, taking the reference inter motion vector corresponding to the reference primary scaled video bitstream as search starting point information, the fine motion vector search is performed on the reference primary scaled video bitstream to determine the target inter motion vector corresponding to the reference primary scaled video bitstream. Then, the encoding is performed on the reference primary scaled video bitstream based on the target inter motion vector corresponding to the reference primary scaled video bitstream to obtain the encoded video bitstream corresponding to the reference primary scaled video bitstream.

FIG. 4 is a structural diagram of respectively encoding 4 transcoding tasks provided by an embodiment of the disclosure. As shown in FIG. 4, a first encoder B0 encodes the reference primary scaled video bitstream that has the first resolution and corresponds to the transcoding task 0. The first encoder B0 includes a first rough motion vector search engine C0 and a first fine motion vector search engine DO.

The first rough motion vector search engine C0 is configured to perform the rough motion vector search on the reference primary scaled video bitstream corresponding to the transcoding task 0 to determine a reference inter motion vector corresponding to the transcoding task 0. Then, taking the reference inter motion vector corresponding to the transcoding task 0 as search starting point information corresponding to the transcoding task 0, the first fine motion vector search engine DO performs the fine motion vector search on the reference primary scaled video bitstream based on the search starting point information corresponding to the transcoding task 0 to determine a target inter motion vector corresponding to the transcoding task 0. In some implementations, the encoder 0 is configured to encode the reference primary scaled video bitstream based on the target inter motion vector corresponding to the transcoding task 0 to obtain an encoded video bitstream corresponding to the transcoding task 0.

In some implementations, the operation that the encoding is performed on each of the recovered N primary scaled video bitstreams to obtain the N encoded video bitstreams includes the following operations. For any non-reference primary scaled video bitstream, the rough motion vector search is performed on the non-reference primary scaled video bitstream to determine a reference inter motion vector corresponding to the non-reference primary scaled video bitstream. The fine motion vector search is performed on the non-reference primary scaled video bitstream based on the reference inter motion vector corresponding to the non-reference primary scaled video bitstream and the reference inter motion vector corresponding to the reference primary scaled video bitstream to determine a target inter motion vector corresponding to the non-reference primary scaled video bitstream. The encoding is performed on the non-reference primary scaled video bitstream based on the target inter motion vector corresponding to the non-reference primary scaled video bitstream to obtain an encoded video bitstream corresponding to the non-reference primary scaled video bitstream.

In addition, the reference inter motion vector corresponding to the reference primary scaled video bitstream is stored in a corresponding shared cache space, such that when the non-reference primary scaled video bitstream is encoded, the reference inter motion vector corresponding to the reference primary scaled video bitstream may be acquired from the shared cache space and taken as reference information, thereby providing more search starting point information for the fine motion search process.

For any non-reference primary scaled video bitstream, the rough motion vector search is performed on the non-reference primary scaled video bitstream to determine the reference inter motion vector corresponding to the non-reference primary scaled video bitstream. Then, the reference inter motion vector corresponding to the reference primary scaled video bitstream is acquired, and scaling is performed to obtain a scaled reference inter motion vector corresponding to the resolution of the reference primary scaled video bitstream. In such case, search starting point information may be determined according to the reference inter motion vector corresponding to the non-reference primary scaled video bitstream and the scaled reference inter motion vector, such that the fine motion vector search is performed on the non-reference primary scaled video bitstream to determine the target inter motion vector corresponding to the non-reference primary scaled video bitstream. Then, the encoding is performed on the non-reference primary scaled video bitstream based on the target inter motion vector corresponding to the non-reference primary scaled video bitstream to obtain the encoded video bitstream corresponding to the non-reference primary scaled video bitstream.

The above FIG. 4 is taken as an example. As shown in FIG. 4, a reference inter motion vector E0 that corresponds to the transcoding task 0 and is output by the first rough motion vector search engine C0 is stored in a corresponding shared cache space F, which allows for sharing during the encoding process of other non-reference primary scaled video bitstreams.

As shown in FIG. 4, a second encoder B1 encodes the non-reference primary scaled video bitstream that has the second resolution and corresponds to the transcoding task 1. The second encoder B1 includes a second rough motion vector search engine C1 and a second fine motion vector search engine D1.

The second rough motion vector search engine C1 performs the rough motion vector search on the non-reference primary scaled video bitstream corresponding to the transcoding task 1 to determine a reference inter motion vector E1 corresponding to the transcoding task 1. Then, the scaling is performed on the reference inter motion vector E1 corresponding to the transcoding task 0 in the shared cache space F to obtain a scaled reference inter motion vector corresponding to the resolution of the transcoding task 1. In such case, search starting point information corresponding to the transcoding task 1 may be determined according to the reference inter motion vector corresponding to the transcoding task 1 and the scaled reference inter motion vector corresponding to the resolution of transcoding task 1. The second fine motion vector search engine D1 performs the fine motion vector search on the non-reference primary scaled video bitstream corresponding to the transcoding task 1 based on the search starting point information corresponding to the transcoding task 1 to determine a target inter motion vector E1 corresponding to the transcoding task 1. In some embodiments, the encoder 1 encodes the non-reference primary scaled video bitstream corresponding to the transcoding task 1 based on the target inter motion vector E1 corresponding to the transcoding task 1 to obtain an encoded video bitstream corresponding to the transcoding task 1.

As shown in FIG. 4, a third encoder B2 encodes the non-reference primary scaled video bitstream that has the third resolution and corresponds to the transcoding task 2. The third encoder B2 includes a third rough motion vector search engine C2 and a third fine motion vector search engine D2. A fourth encoder B3 encodes the non-reference primary scaled video bitstream that has the fourth resolution and corresponds to the transcoding task 3. The fourth encoder B3 includes a fourth rough motion vector search engine C3 and a fourth fine motion vector search engine D3.

The specific processes of encoding the non-reference primary scaled video bitstreams corresponding to the transcoding task 2 and the transcoding task 3 to obtain the encoded video bitstreams corresponding to the transcoding task 2 and the transcoding task 3 are similar to the above process of encoding the non-reference primary scaled video bitstream corresponding to the transcoding task 1 to obtain the encoded video bitstream corresponding to the transcoding task 1.

The encoding process of the non-reference primary scaled video bitstream shares the reference inter motion vector corresponding to the reference primary scaled video bitstream, which provides more search starting point determination information for the subsequent fine motion vector search, thereby effectively improving the accuracy of inter prediction and improving the encoding performance.

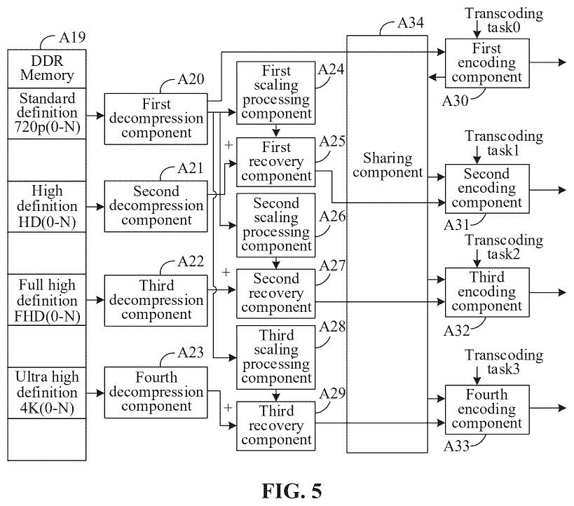

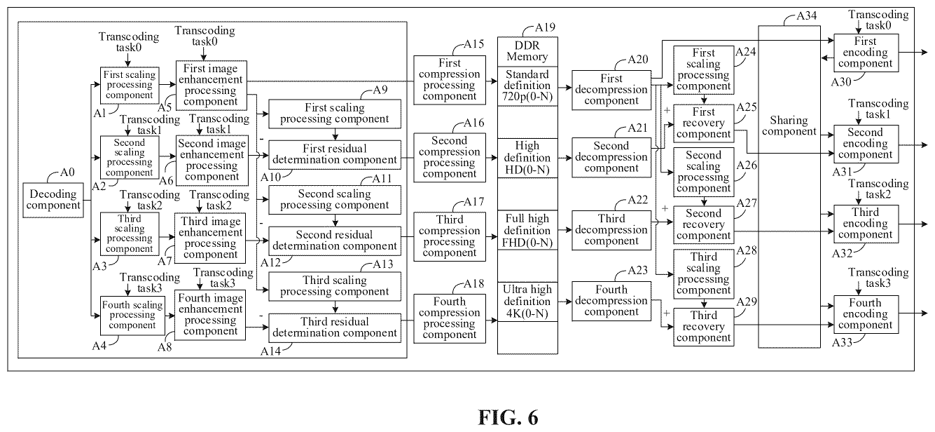

FIG. 5 is a structural diagram of a system for video transcoding provided by an embodiment of the disclosure. As shown in FIG. 5, the system for video transcoding includes a DDR memory A19, a first decompression component A20, a decompression component A21, a decompression component A22 and a decompression component A23. When the video data is required, the decompression component A20 reads the first video compression data from the DDR memory A19 and decompresses the first video compression data through a general video decompression mode (e.g., the intra lossless decompression mode) to obtain the reference primary scaled video bitstream corresponding to the transcoding task 0. The decompression component A21, the decompression component A22 and the decompression component A23 respectively read the second video compression data from the DDR memory A19 and decompress the second video compression data through the frequency-domain to time-domain decompression mode to obtain the residual video bitstreams corresponding to the transcoding tasks 1 to 3.

The system for video transcoding further includes a first scaling processing component A24, a second scaling processing component A26 and a third scaling processing component A28. The first scaling processing component A24, the second scaling processing component A26 and the third scaling processing component A28 respectively scale the reference primary scaled video bitstream that corresponds to the transcoding task 0 and is output by the first decompression processing component A20 to obtain secondary scaled video bitstreams with the same resolutions as the non-reference primary scaled video bitstreams corresponding to the transcoding tasks 1 to 3.

The system for video transcoding further includes a first recovery component A25, a second recovery component A27 and a third recovery component A29. The first recovery component A25 performs addition on the residual video bitstream that corresponds to the transcoding task 1 and is output by the second decompression component A21, and the secondary scaled video bitstream that corresponds to the transcoding task 1 and is output by the first scaling processing component A24, so as to obtain a primary scaled video bitstream corresponding to the transcoding task 1. The second recovery component A27 performs addition on the residual video bitstream that corresponds to the transcoding task 2 and is output by the third decompression component A22, and the secondary scaled video bitstream that corresponds to the transcoding task 2 and is output by the second scaling processing component A26, so as to obtain a primary scaled video bitstream corresponding to the transcoding task 2. The third recovery component A29 performs addition on the residual video bitstream that corresponds to the transcoding task 3 and is output by the fourth decompression component A23, and the secondary scaled video bitstream that corresponds to the transcoding task 3 and is output by the third scaling processing component A28, so as to obtain a primary scaled video bitstream corresponding to the transcoding task 3.

The system for video transcoding further includes a first encoding component A30, a second encoding component A31, a third encoding component A32 and a fourth encoding component A33. The first encoding component A30 is configured to encode and output the reference primary scaled video bitstream that corresponds to the transcoding task 0 and is output by the first decompression component A20. The second encoding component A31 is configured to encode and output the reference primary scaled video bitstream that corresponds to the transcoding task 1 and is output by the first recovery component A25. The third encoding component A32 is configured to encode and output the reference primary scaled video bitstream that corresponds to the transcoding task 2 and is output by the second recovery component A27. The fourth encoding component A33 is configured to encode and output the reference primary scaled video bitstream that corresponds to the transcoding task 3 and is output by the third recovery component A29.

The system for video transcoding further includes a sharing component A34. During the encoding process, the reference inter motion vector obtained by performing the rough motion vector search on the reference primary scaled video bitstream corresponding to the transcoding task 0 is stored in the sharing component A34, such that when the non-reference primary scaled video bitstreams corresponding to the transcoding tasks 1 to 3 are encoded, the reference inter motion vector of the reference primary scaled video bitstream corresponding to the transcoding task 0 may be shared. The specific process may be referred to the related contents in the above embodiments.

FIG. 6 is a structural diagram of a system for video transcoding provided by an embodiment of the disclosure. As shown in FIG. 6, the system for video transcoding includes all components in the above FIG. 2 and FIG. 5, which together complete the entire process from that the video bitstream to be processed is input to that the encoded bitstream is finally output. The specific process may be referred to the related description of the above FIG. 2 and FIG. 5.

It is to be understood that the above various method embodiments mentioned in the disclosure may be combined with each other to form combined embodiments without violating the principles or logic. Those skilled in the art may understand that in the above method of the specific implementations, the specific execution order of the operations should be determined in accordance with their functions and possible inherent logic.

Based on the same inventive concept, an apparatus for video transcoding corresponding to the method for video transcoding is further provided in an embodiment of the disclosure. Since the principle of solving problems of the apparatus in the embodiment of the disclosure is similar to that of the above method for video transcoding in the embodiments of the disclosure, the implementation of the apparatus may be referred to the implementation of the method.

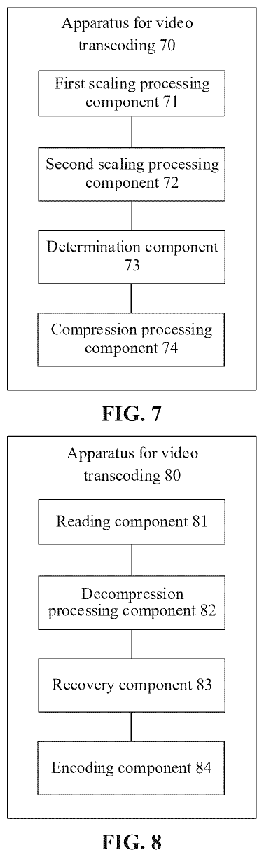

FIG. 7 is a block diagram of an apparatus for video transcoding provided by an embodiment of the disclosure. As shown in FIG. 7, the apparatus for video transcoding 70 includes a first scaling processing component 71, a second scaling processing component 72, a determination component 73 and a compression processing component 74.

The first scaling processing component 71 is configured to scale an original video bitstream based on N first preset scaling parameters to obtain N primary scaled video bitstreams with different resolutions. Here, N is a positive integer greater than or equal to 2.

The second scaling processing component 72 is configured to scale a reference primary scaled video bitstream to obtain N-1 secondary scaled video bitstreams corresponding to resolutions of N-1 non-reference primary scaled video bitstreams other than the reference primary scaled video bitstream. Here, the reference primary scaled video bitstream is one of the N primary scaled video bitstreams.

The determination component 73 is configured to determine N-1 residual video bitstreams based on the N-1 non-reference primary scaled video bitstreams and the N-1 secondary scaled video bitstreams.

The compression processing component 74 is configured to compress the reference primary scaled video bitstream and the N-1 residual video bitstreams to obtain video compression data.

In some implementations, the apparatus 70 further includes an image enhancement processing component. The image enhancement processing component is configured to perform image enhancement on each of the N primary scaled video bitstreams before scaling the reference primary scaled video bitstream.

In some implementations, the apparatus 70 further includes an acquisition component and a decoding component. The acquisition component is configured to acquire a video bitstream to be processed. The decoding component is configured to decode the video bitstream to be processed to obtain the original video bitstream.

In some implementations, the reference primary scaled video bitstream is a primary scaled video bitstream with the lowest resolution among the N primary scaled video bitstreams.

In some implementations, the video compression data includes first video compression data. The compression processing component 74 is further configured to compress the reference primary scaled video bitstream based on an intra lossless compression mode to obtain the first video compression data.

In some implementations, the video compression data includes second video compression data. The compression processing component 74 is further configured to compress the N-1 residual video bitstreams based on a time-domain to frequency-domain compression mode to obtain the second video compression data.

In some implementations, the apparatus 70 further includes a storage component. The storage component is configured to store the video compression data in a DDR memory.

The above description of the apparatus embodiments is similar to that of the above method embodiments, and the apparatus embodiments have beneficial effects similar to those of the above method embodiments. For technical details not disclosed in the apparatus embodiments of the disclosure, reference can be made to the description of the method embodiments of the disclosure for understanding.

FIG. 8 is a block diagram of an apparatus for video transcoding provided by an embodiment of the disclosure. As shown in FIG. 8, the apparatus for video transcoding 80 includes a reading component 81, a decompression processing component 82, a recovery component 83 and an encoding component 84.

The reading component 81 is configured to read video compression data from a DDR memory. Here, the video compression data is obtained according to the above method.

The decompression processing component 82 is configured to decompress the video compression data to obtain a reference primary scaled video bitstream and N-1 residual video bitstreams. Here, N is a positive integer greater than or equal to 2.

The recovery component 83 is configured to recover N primary scaled video bitstreams based on the reference primary scaled video bitstream and the N-1 residual video bitstreams.

The encoding component 84 is configured to encode each of the recovered N primary scaled video bitstreams to obtain N encoded video bitstreams.

In some implementations, the video compression data includes first video compression data. The decompression processing component 82 is further configured to decompress the first video compression data based on an intra lossless decompression mode to obtain the reference primary scaled video bitstream.

In some implementations, the video compression data includes second video compression data. The decompression processing component 82 is further configured to decompress the second video compression data based on a frequency-domain to time-domain decompression mode to obtain the N-1 residual video bitstreams.

In some implementations, during the encoding process, the N primary scaled video bitstreams share a reference inter motion vector corresponding to the reference primary scaled video bitstream.

In some implementations, the encoding component 84 is further configured to: perform rough motion vector search on the reference primary scaled video bitstream to determine the reference inter motion vector corresponding to the reference primary scaled video bitstream; perform fine motion vector search on the reference primary scaled video bitstream based on the reference inter motion vector corresponding to the reference primary scaled video bitstream to determine a target inter motion vector corresponding to the reference primary scaled video bitstream; and encode the reference primary scaled video bitstream based on the target inter motion vector corresponding to the reference primary scaled video bitstream to obtain an encoded video bitstream corresponding to the reference primary scaled video bitstream.

In some implementations, the encoding component 84 is further configured to: for any non-reference primary scaled video bitstream, perform the rough motion vector search on the non-reference primary scaled video bitstream to determine a reference inter motion vector corresponding to the non-reference primary scaled video bitstream; perform the fine motion vector search on the non-reference primary scaled video bitstream based on the reference inter motion vector corresponding to the non-reference primary scaled video bitstream and the reference inter motion vector corresponding to the reference primary scaled video bitstream to determine a target inter motion vector corresponding to the non-reference primary scaled video bitstream; and encode the non-reference primary scaled video bitstream based on the target inter motion vector corresponding to the non-reference primary scaled video bitstream to obtain an encoded video bitstream corresponding to the non-reference primary scaled video bitstream.

The above description of the apparatus embodiments is similar to that of the above method embodiments, and the apparatus embodiments have beneficial effects similar to those of the above method embodiments. For technical details not disclosed in the apparatus embodiments of the disclosure, reference can be made to the description of the method embodiments of the disclosure for understanding.

The method has specific technical association with the internal structure of the computer system, and may solve technical problems of how to improve hardware operational efficiency or execution effects (including reducing data storage volume, reducing data transmission volume, increasing hardware processing speed, or the like), thereby obtaining technical effects of improving internal performance of the computer system in accordance with natural laws.

In the embodiments of the disclosure and other embodiments, the term “component” may be a part of a circuit, a part of a processor, a part of a program or software, or the like. Of course, it may also be a unit or a module, or may be non-modular.

In some implementations, the apparatus provided by the implementations of the disclosure has functions or includes components that may be used to perform the method described in the above method embodiments, and the specific implementation may be referred to the description of the above method embodiments.

An implementation of the disclosure provides a computer-readable storage medium having stored thereon computer program instructions that, when executed by a processor, implement the above method. The computer-readable storage medium may be a volatile or a non-volatile computer-readable storage medium.

An implementation of the disclosure provides an electronic device including a processor and a memory for storing instructions executable by the processor. The processor is configured to call the instructions stored in the memory to perform the above method.

An implementation of the disclosure provides a computer program product including computer-readable codes or a non-volatile computer-readable storage medium carrying computer-readable codes. When the computer-readable codes are run in a processor of an electronic device, the processor of the electronic device performs the above method.

The electronic device may be provided as a terminal, a server, or other forms of devices.

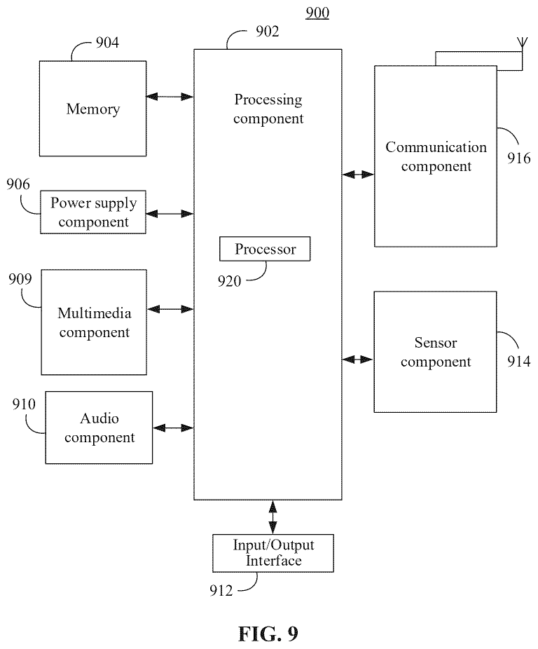

FIG. 9 is a block diagram of an electronic device provided by an embodiment of the disclosure. As shown in FIG. 9, the electronic device 900 may be a terminal device such as User Equipment (UE), a mobile device, a user terminal, a terminal, a cellular phone, a cordless phone, a Personal Digital Assistant (PDA), a handheld device, a computing device, an onboard device, a wearable device, or the like.

With reference to FIG. 9, the electronic device 900 may include one or more of the following components: a processing component 902, a memory 904, a power supply component 906, a multimedia component 908, an audio component 910, an input/output interface 912, a sensor component 914, or a communication component 916.

The processing component 902 generally controls overall operations of the electronic device 900, such as operations associated with display, telephone calls, data communication, camera operations, and recording operations. The processing component 902 may include one or more processors 920 to execute instructions to complete all or part of the operations of the above method. In addition, the processing component 902 may include one or more parts to facilitate interaction between the processing component 902 and other components. For example, the processing component 902 may include a multimedia part to facilitate the interaction between the multimedia component 908 and the processing component 902.

The memory 904 is configured to store various types of data to support operations on the electronic device 900. Examples of the data include instructions of any applications or methods for operations on the electronic device 900, contact data, phone book data, messages, pictures, videos, or the like. The memory 904 may be implemented by any types of volatile or non-volatile storage device, or a combination thereof, such as a Static Random-Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk, or an optical disk.

The power supply component 906 provides power to various components of the electronic device 900. The power supply component 906 may include a power management system, one or more power supplies, and other components associated with generating, managing, and distributing power for the electronic device 900.

The multimedia component 908 includes a screen that provides an output interface between the electronic device 900 and the user. In some embodiments, the screen may include a Liquid Crystal Display (LCD) and a Touch Panel (TP). If the screen includes a touch panel, the screen may be implemented as a touchscreen to receive input signals from the user. The touch panel includes one or more touch sensors to sense touch, sliding, and gestures on the touch panel. The touch sensors may not only sense boundaries of touch or sliding actions, but also detect duration and pressure associated with the touch or sliding actions. In some embodiments, the multimedia component 908 may include at least one of a front camera or a rear camera. When the electronic device 900 is in an operating mode, such as a camera mode or a video mode, at least one of the front camera or the rear camera may receive external multimedia data. Each front camera and each rear camera may be a fixed optical lens system, or may have a focal length and an optical zoom capability.

The audio component 910 is configured to output and/or input audio signals. For example, the audio component 910 includes a Microphone (MIC). When the electronic device 900 is in the operating mode (such as a call mode, a recording mode, or a voice recognition mode), the microphone is configured to receive external audio signals. The received audio signals may be further stored in the memory 904 or sent via the communication component 916. In some embodiments, the audio component 910 further includes a speaker for outputting audio signals.

The input/output interface 912 provides an interface between the processing component 902 and a peripheral interface part. The above peripheral interface part may be a keyboard, a click wheel, a button, or the like. These buttons may include a home button, a volume button, a start button and a lock button, but are not limited thereto.

The sensor component 914 includes one or more sensors to provide status assessments in various aspects for the electronic device 900. For example, the sensor component 914 may detect a turn-on/turn-off status of the electronic device 900, or relative positioning of the components. For example, the components are the display and the keypad of the electronic device 900, the sensor component 914 may further detect a position change of the electronic device 900 or a component of the electronic device 900, an existence or non-existence of the contact between the user and the electronic device 900, an orientation or acceleration/deceleration of the electronic device 900, or a temperature change of the electronic device 900. The sensor component 914 may include a proximity sensor configured to detect an existence of nearby objects without any physical contact. The sensor component 914 may further include a photosensor, such as a Complementary Metal Oxide Semiconductor (CMOS) or Charge Coupled Device (CCD) image sensor, which is used in imaging applications. In some embodiments, the sensor component 914 may further include an acceleration sensor, a gyro sensor, a magnetic sensor, a pressure sensor or a temperature sensor.

The communication component 916 is configured to facilitate wired or wireless communication between the electronic device 900 and other devices. The electronic device 900 may access wireless networks based on communication standards, such as Wireless Fidelity (Wi-Fi), 2nd Generation Mobile Communication Technology (2G), 3rd Generation Mobile Communication Technology (3G), 4th Generation Mobile Communication Technology (4G), Long Term Evolution (LTE) of the Mobile Communication Technology, 5th Generation Mobile Communication Technology (5G), or a combination thereof. In an exemplary embodiment, the communication component 916 receives broadcast signals or broadcast-related information from an external broadcast management system via a broadcast channel. In an exemplary embodiment, the communication component 916 further includes a Near Field Communication (NFC) part to facilitate short-range communication. For example, the NFC part may be implemented based on Radio Frequency Identification (RFID) technology, Infrared Data Association (IrDA) technology, Ultra Wide Band (UWB) technology, Bluetooth (BT) technology, or other technologies.

In an exemplary embodiment, the electronic device 900 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic elements to perform the above method.

In an exemplary embodiment, a non-volatile computer-readable storage medium is further provided, such as the memory 904 including computer program instructions. The above computer program instructions may be executed by the processor 920 of the electronic device 900 to complete the above method.

The disclosure relates to the field of augmented reality. Image information of a target object in the real environment is acquired, and various vision-related algorithms are used to achieve detection or recognition on related features, states and attributes of the target object, thereby obtaining an Augmented Reality (AR) effect that combines virtuality and reality and matches specific applications. Exemplarily, the target object may involve: faces, limbs, gestures and movements related to human bodies; markers and signs related to objects; or sand tables, display areas or displayed objects related to venues or places. The vision-related algorithms may involve visual localization, Simultaneous Localization And Mapping (SLAM), 3D reconstruction, image registration, background segmentation, keypoint extraction and tracking of objects, pose or depth detection of objects, or the like. Specific applications may not only involve interactive scenarios related to real scenarios or objects, such as guidance, navigation, explanation, reconstruction, and superimposed virtual effect display, but also human-related special effect processing, such as makeup beautification, limb beautification, special effect display, and virtual model display. The detection or recognition on related features, states and attributes of the target object may be achieved by a convolutional neural network. The above convolutional neural network is a network model obtained by performing model training based on deep learning frameworks.

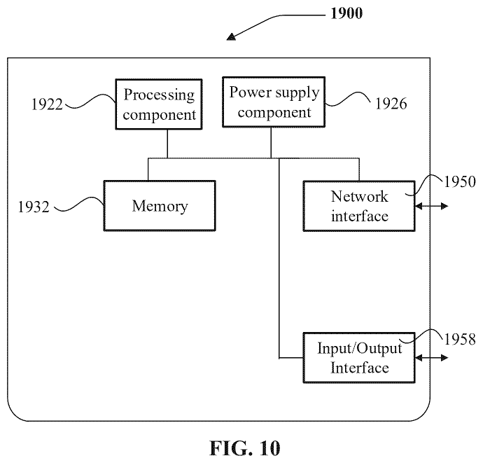

Reference is made to FIG. 10, which is a block diagram of an electronic device provided by an embodiment of the disclosure. As shown in FIG. 10, an electronic device 1900 may be provided as a server or a terminal device. With reference to FIG. 10, the electronic device 1900 includes a processing component 1922 which further includes one or more processors, and a memory resource represented by a memory 1932 which is configured to store instructions executable by the processing component 1922, such as applications. The applications stored in the memory 1932 may include one or more parts, each of which corresponds to a group of instructions. In addition, the processing component 1922 is configured to execute instructions to perform the above method.

The electronic device 1900 may further include a power supply component 1926 configured to perform power management of the electronic device 1900, a wired or wireless network interface 1950 configured to connect the electronic device 1900 to a network, and an input/output interface 1958. The electronic device 1900 may operate based on an operating system stored in the memory 1932, such as a Microsoft Server Operating System (Windows Server™), an Apple's graphical user interface-based operating system (Mac OS X™), a multi-user multi-process computer operating system (Unix™), a free and open-source Unix-like operating system (Linux™), an open-source Unix-like operating system (FreeBSD™), or the like.

In an exemplary embodiment, a non-volatile computer-readable storage medium is further provided, such as the memory 1932 including computer program instructions. The above computer program instructions may be executed by the processing component 1922 of the electronic device 1900 to complete the above method.

The disclosure may be at least one of a system, a method, or a computer program product. The computer program product may include a computer-readable storage medium, which may be a volatile storage medium or a non-volatile storage medium, and has stored thereon computer-readable program instructions for enabling a processor to implement various aspects of the disclosure.

The computer-readable storage medium may be a tangible device that may retain and store instructions used by an instruction execution device. The computer-readable storage medium, for example, may be an electronic storage device, a magnetic storage device, an optical storage device, an electromagnetic storage device, a semiconductor storage device, or any suitable combination of the above, but is not limited thereto. More specific examples (a non-exhaustive list) of the computer-readable storage medium include a portable computer disk, a hard disk, a Random Access Memory (RAM), a Read-Only Memory (ROM), an Erasable Programmable Read Only Memory (EPROM), a Static Random-Access Memory (SRAM), a Compact Disc Read-Only Memory (CD-ROM), a Digital Versatile/Video Disc (DVD), a memory stick, a floppy disk, a mechanical encoding device (e.g., a punched card or a raised structure within a groove, which has stored thereon instructions), and any suitable combination of the above. The computer-readable storage medium used here is not interpreted as a transient signal itself, such as a radio wave or other freely propagating electromagnetic waves, an electromagnetic wave propagated through a waveguide or other transmission media (e.g., a light pulse through a fiber optic cable), or an electrical signal transmitted through a wire.

The computer-readable program instructions described here may be downloaded to various computing/processing devices from the computer-readable storage medium, or downloaded to external computers or external storage devices through a network, such as at least one of the Internet, a local area network, a wide area network, or a wireless network. The network may include at least one of a copper transmission cable, optical fiber transmission, wireless transmission, a router, a firewall, a switch, a gateway computer, or an edge server. The network adapter or network interface in each computing/processing device receives computer-readable program instructions from the network and forwards the computer-readable program instructions to be stored in the computer-readable storage medium within various computing/processing devices.

The computer program instructions for performing the operations of the disclosure may be assembly instructions, Instruction-Set Architecture (ISA) instructions, machine instructions, machine-related instructions, microcodes, firmware instructions, state-setting data, or source codes or target codes written in any combination of one or more programming languages. The programming languages include object-oriented programming languages such as Smalltalk, C++, or the like, and conventional procedural programming languages such as the “C” language or similar programming languages. The computer-readable program instructions may be executed entirely on the user's computer, partially on the user's computer, as an independent software package, partially on the user's computer and partially on a remote computer, or entirely on a remote computer or server. In a case related to a remote computer, the remote computer may be connected to the user's computer through any type of network (which includes a Local Area Network (LAN) or a Wide Area Network (WAN)), or may be connected to an external computer (e.g., connected through the Internet by using an Internet service provider). In some embodiments, an electronic circuit, such as a programmable logic circuit, a Field Programmable Gate Array (FPGA), or a Programmable Logic Array (PLA), may be customized by using state information of the computer-readable program instructions. The electronic circuit may execute the computer-readable program instructions, thereby implementing various aspects of the disclosure.

Here, various aspects of the disclosure are described with reference to flowcharts and/or block diagrams according to the method, apparatus (system), and computer program product of the embodiments of the disclosure. It is to be understood that each block in the flowcharts and/or block diagrams, as well as combinations of blocks in the flowcharts and/or block diagrams, may be implemented by the computer-readable program instructions.

These computer-readable program instructions may be provided to the processor of a general purpose computer, a special purpose computer, or other programmable data processing apparatuses to produce a machine, such that these instructions, when executed by the processor of a computer or other programmable data processing apparatuses, generate an apparatus for implementing functions/actions specified in one or more blocks in the flowcharts and/or block diagrams. These computer-readable program instructions may also be stored in a computer-readable storage medium, and these instructions enable a computer, a programmable data processing apparatus, and/or other devices to operate in a specific manner, such that the computer-readable medium having stored the instructions includes an manufactured product, which includes instructions that implement various aspects of the functions/actions specified in one or more blocks in the flowcharts and/or block diagrams.

The computer-readable program instructions may also be loaded onto a computer, other programmable data processing apparatuses or other devices, so as to perform a series of operational steps on the computer, other programmable data processing apparatuses or other devices to generate a computer-implemented process, such that the instructions executed on the computer, other programmable data processing apparatuses or other devices implement the functions/actions specified in one or more blocks in the flowcharts and/or block diagrams.

Flowcharts and block diagrams in the drawings illustrate the architecture, functions and operations of possible implementations of the system, method and computer program product according to various embodiments of the disclosure. In this regard, each block in the flowcharts or block diagrams may represent a part, a program segment, or a part of instructions that include one or more executable instructions configured to implement specified logical functions. In some alternative implementations, the functions marked in the blocks may occur in an order different from the order marked in the drawings. For example, two continuous blocks may actually be performed substantially in parallel, or in the reverse order, depending on the involved functions. It is also to be noted that each block in the block diagrams and/or flowcharts, and combinations of blocks in the block diagrams and/or flowcharts, may be implemented by a dedicated hardware-based system that performs specified functions or actions, or by a combination of dedicated hardware and computer instructions.

The computer program product may be specifically implemented by hardware, software, or a combination thereof. In an optional embodiment, the computer program product is specifically embodied as a computer storage medium. In another optional embodiment, the computer program product is specifically embodied as a software product, such as a Software Development Kit (SDK), or the like. The above description of the various embodiments tends to emphasize the differences between the embodiments, and the same or similar aspects may be referred mutually.

Those skilled in the art may understand that in the above method of the specific implementations, the written order of the operations does not mean a strict execution order and does not constitute any limitation on the implementation process. The specific execution order of the operations should be determined by their functions and possible inherent logic.

If the technical solution of the disclosure is related to personal information, the product applying the technical solution of the disclosure has clearly informed processing rules of personal information and obtained the individual's voluntary consent before processing the personal information. If the technical solution of the disclosure is related to sensitive personal information, the product applying the technical solution of the disclosure has obtained the individual's separate consent and further met requirements of “explicit consent” before processing the sensitive personal information. For example, at the location of a personal information collection apparatus such as a camera, a clear and conspicuous sign is set to inform that the personal information collection area has been entered, and personal information will be collected. If an individual voluntarily enters the collection area, it is considered as consent to collect the personal information. Alternatively, in a case where an obvious sign/information is used to inform the processing rules of personal information on an apparatus for processing personal information, individual authorization is obtained through a pop-up message, or by asking an individual to upload the personal information himself. Here, the processing rules of personal information may include information such as the processor of the personal information, the purpose of processing personal information, the processing method, the types of personal information to be processed, or the like.

Various embodiments of the disclosure have been described above. The above illustration is exemplary and not exhaustive, and is not limited to the disclosed embodiments. Many modifications and variations are apparent to those of ordinary skill in the art without departing from the scope and spirit of the illustrated embodiments. Selection of terms used herein is intended to best explain principles of the embodiments, practical applications, or improvement on technologies over the market, or to enable other ordinary skilled persons in the art to understand the disclosed embodiments herein.

### INDUSTRIAL APPLICABILITY

Embodiments of the disclosure provide a method for video transcoding and an apparatus, an electronic device, a computer-readable storage medium, and a computer program product. The method for video transcoding includes the following operations. Scaling is performed on an original video bitstream based on N first preset scaling parameters to obtain N primary scaled video bitstreams with different resolutions. N is a positive integer greater than or equal to 2. The scaling is performed on a reference primary scaled video bitstream to obtain N-1 secondary scaled video bitstreams corresponding to resolutions of N-1 non-reference primary scaled video bitstreams other than the reference primary scaled video bitstream. The reference primary scaled video bitstream is one of the N primary scaled video bitstreams. N-1 residual video bitstreams are determined based on the N-1 non-reference primary scaled video bitstreams and the N-1 secondary scaled video bitstreams. Compression is performed on the reference primary scaled video bitstream and the N-1 residual video bitstreams to obtain video compression data. With the above solution, in a complex video transcoding scenario, the residual video bitstream is determined through two scaling operations, which may effectively reduce the amount of data that needs to be transmitted and stored during the video transcoding process, and then effectively reduce the occupancy rate of the DDR memory and bandwidth during the video transcoding process, thereby improving video transcoding efficiency.

1. A method for video transcoding, comprising:
scaling an original video bitstream based on N first preset scaling parameters to obtain N primary scaled video bitstreams with different resolutions, wherein N is a positive integer greater than or equal to 2;
scaling a reference primary scaled video bitstream to obtain N-1 secondary scaled video bitstreams corresponding to resolutions of N-1 non-reference primary scaled video bitstreams other than the reference primary scaled video bitstream, wherein the reference primary scaled video bitstream is one of the N primary scaled video bitstreams;
determining N-1 residual video bitstreams based on the N-1 non-reference primary scaled video bitstreams and the N-1 secondary scaled video bitstreams; and
compressing the reference primary scaled video bitstream and the N-1 residual video bitstreams to obtain video compression data.

2. The method of claim 1, further comprising:
performing image enhancement on each of the N primary scaled video bitstreams before scaling the reference primary scaled video bitstream.

3. The method of claim 1, further comprising:
acquiring a video bitstream to be processed; and
decoding the video bitstream to be processed to obtain the original video bitstream.

4. The method of claim 1, wherein the reference primary scaled video bitstream is a primary scaled video bitstream with a lowest resolution in the N primary scaled video bitstreams.

5. The method of claim 1, wherein the video compression data comprises first video compression data;
wherein compressing the reference primary scaled video bitstream to obtain the video compression data comprises:
compressing the reference primary scaled video bitstream based on an intra lossless compression mode to obtain the first video compression data.

6. The method of claim 1, wherein the video compression data comprises second video compression data;
wherein compressing the N-1 residual video bitstreams to obtain the video compression data comprises:
compressing the N-1 residual video bitstreams based on a time-domain to frequency-domain compression mode to obtain the second video compression data.

7. The method of claim 1, further comprising:
storing the video compression data in a Double Data Rate (DDR) memory.

8. A method for video transcoding, comprising:
reading video compression data from a Double Data Rate (DDR) memory, wherein the video compression data is obtained according to the method of claim 1;
decompressing the video compression data to obtain a reference primary scaled video bitstream and N-1 residual video bitstreams, wherein N is a positive integer greater than or equal to 2;
recovering N primary scaled video bitstreams based on the reference primary scaled video bitstream and the N-1 residual video bitstreams; and
encoding each of the recovered N primary scaled video bitstreams to obtain N encoded video bitstreams.

9. The method of claim 8, wherein the video compression data comprises first video compression data;
wherein decompressing the video compression data to obtain the reference primary scaled video bitstream comprises:
decompressing the first video compression data based on an intra lossless decompression mode to obtain the reference primary scaled video bitstream.

10. The method of claim 8, wherein the video compression data comprises second video compression data;
wherein decompressing the video compression data to obtain the N-1 residual video bitstreams comprises:
decompressing the second video compression data based on a frequency-domain to time-domain decompression mode to obtain the N-1 residual video bitstreams.

11. The method of claim 8, wherein during the encoding, the N primary scaled video bitstreams share a reference inter motion vector corresponding to the reference primary scaled video bitstream.

12. The method of claim 11, wherein encoding each of the recovered N primary scaled video bitstreams to obtain the N encoded video bitstreams comprises:
performing rough motion vector search on the reference primary scaled video bitstream to determine the reference inter motion vector corresponding to the reference primary scaled video bitstream;
performing fine motion vector search on the reference primary scaled video bitstream based on the reference inter motion vector corresponding to the reference primary scaled video bitstream to determine a target inter motion vector corresponding to the reference primary scaled video bitstream; and
encoding the reference primary scaled video bitstream based on the target inter motion vector corresponding to the reference primary scaled video bitstream to obtain an encoded video bitstream corresponding to the reference primary scaled video bitstream.

13. The method of claim 11, wherein encoding each of the recovered N primary scaled video bitstreams to obtain the N encoded video bitstreams comprises:
for any non-reference primary scaled video bitstream, performing rough motion vector search on the non-reference primary scaled video bitstream to determine a reference inter motion vector corresponding to the non-reference primary scaled video bitstream;
performing fine motion vector search on the non-reference primary scaled video bitstream based on the reference inter motion vector corresponding to the non-reference primary scaled video bitstream and the reference inter motion vector corresponding to the reference primary scaled video bitstream to determine a target inter motion vector corresponding to the non-reference primary scaled video bitstream; and
encoding the non-reference primary scaled video bitstream based on the target inter motion vector corresponding to the non-reference primary scaled video bitstream to obtain an encoded video bitstream corresponding to the non-reference primary scaled video bitstream.

14. A device for video transcoding, comprising:
a memory for storing a computer program; and
a processor, wherein the processor is configured to execute the computer program to:
scale an original video bitstream based on N first preset scaling parameters to obtain N primary scaled video bitstreams with different resolutions, wherein N is a positive integer greater than or equal to 2;
scale a reference primary scaled video bitstream to obtain N-1 secondary scaled video bitstreams corresponding to resolutions of N-1 non-reference primary scaled video bitstreams other than the reference primary scaled video bitstream, wherein the reference primary scaled video bitstream is one of the N primary scaled video bitstreams;
determine N-1 residual video bitstreams based on the N-1 non-reference primary scaled video bitstreams and the N-1 secondary scaled video bitstreams; and
compress the reference primary scaled video bitstream and the N-1 residual video bitstreams to obtain video compression data.

15. The device of claim 14, wherein the processor is further configured to execute the computer program to:
perform image enhancement on each of the N primary scaled video bitstreams before scaling the reference primary scaled video bitstream.

16. The device of claim 14, wherein the processor is further configured to execute the computer program to:
acquire a video bitstream to be processed; and
decode the video bitstream to be processed to obtain the original video bitstream.

17. The device of claim 14, wherein the reference primary scaled video bitstream is a primary scaled video bitstream with a lowest resolution in the N primary scaled video bitstreams.

18. The device of claim 14, wherein the video compression data comprises first video compression data; wherein the processor is further configured to execute the computer program to:
compress the reference primary scaled video bitstream based on an intra lossless compression mode to obtain the first video compression data.

19. The device of claim 14, wherein the video compression data comprises second video compression data; wherein the processor is further configured to execute the computer program to:
compress the N-1 residual video bitstreams based on a time-domain to frequency-domain compression mode to obtain the second video compression data.

20. The device of claim 14, wherein the processor is further configured to execute the computer program to:
store the video compression data in a Double Data Rate (DDR) memory.

21-29. (canceled)
